(19) United States
(12) Patent Application Publication
(10) Pub. No.: US 2022/0229412 A1
(43) Pub. Date: Jul. 21, 2022

(54) NIR SENSOR CALIBRATION METHOD AND SYSTEM

(71) Applicant: CLAAS Selbstfahrende Erntemaschinen GmbH, Harsewinkel (DE)

(72) Inventors: Björn Stremlau, Recke (DE); Carsten Grove, Beelen (DE); Michael Roggenland, Arnsberg (DE); Frank Claussen, Harsewinkel (DE); Maximilian von Nordheim, Bielefeld (DE); Jeremias Hagel, Münster (DE); Jörg Wesselmann, Harsewinkel (DE)

(73) Assignee: CLAAS Selbstfahrende Erntemaschinen GmbH, Harsewinkel (DE)

(21) Appl. No.: 17/487,743

(22) Filed: Sep. 28, 2021

(30) Foreign Application Priority Data
Sep. 29, 2020 (DE) 102020125422.9

(51) Int. Cl. G05B 19/401

(52) U.S. Cl. CPC G05B 19/401; G05B 2219/39058; G05B 2219/45017

(57) ABSTRACT

Creating NIR sensor calibration models and their use in agricultural work machines is disclosed. A database structure, such as a database structure system, for creating calibration models for an NIR sensor system is used. The database structure includes raw data of the NIR spectra of one or both of plant material and other substances. The raw data are generated by one or more NIR sensor systems assigned to an agricultural work machine. The one or more NIR sensor systems transmit the raw data via an interface for the data traffic with at least one data processing unit external to the agricultural work machine. The database structure comprises one or more calibration models and the raw data, generates user-specific calibration models by using the saved raw data and/or calibration models, and provide user-specific calibration models to a user.

### CROSS REFERENCE TO RELATED APPLICATION

This application claims priority under 35 U.S.C. § 119 to German Patent Application No. DE 102020125422.9 filed Sep. 29, 2020, the entire disclosure of which is hereby incorporated by reference herein.

### TECHNICAL FIELD

The present invention relates to the creation of NIR sensor calibration models and their use in agricultural work machines.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Near-Infrared (NIR) sensors measure the amount of the light transmitted or reflected by a sample in the near infrared range. Organic substances generally have structure-rich absorption or reflection spectra within this spectral range that arises from the excitation of oscillations of bonds between atoms in these substances.

DE 10 2004 048 103 discloses an NIR sensor system in that spectroscopically records properties of streams of substances in an agricultural work machine.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a schematic representation of an example agricultural application using the database structure.

FIG. 2 illustrates a detailed view of an example of the database structure.

FIG. 3 illustrates a schematic representation of the interaction of a user with the database structure.

FIGS. 4A-D illustrates different examples of the database structure.

FIG. 5 illustrates another version of the database structure.

FIG. 6 illustrates another yet another version of the database structure.

### DETAILED DESCRIPTION

As discussed in the background, NIR sensors measure the amount of the light transmitted or reflected by a sample in the near infrared range. Within this spectral range, there are however no distinctive lines that could be assigned to a specific chemical compound; instead, most every organic compound has C—C bonds and C—H bonds whose lines may be shifted slightly from one substance to the other from interactions with adjacent atoms, but they are also so widespread that the shifts may be difficult to identify. Accordingly, the number of degrees of freedom in which the NIR spectra may distinguish different compounds from each other is generally much less than the number of compounds that may be contained in the sample. To be able to extract useful information on the composition of a sample from an NIR spectrum, far-reaching assumptions may be made beforehand about the nature of the sample, and the correctness of these assumptions may determine the validity of the information obtained from the spectrum. In practice, this means that to be able to draw conclusions on important components of a grain sample by analyzing an NIR sample, the type and variety of grain should be known as well as potentially any other influential variables in order to be able to choose an appropriate calibration model for the sample. The optimization of these calibration models is the subject of intensive development. Results obtained by using various calibration models may not be readily comparable with each other.

Also, systems (such as disclosed in DE 10 2004 048 103 B4, referenced in the background) may analyze very precisely determined contents of a flow of substance, and may determine their components in the overall substance flow. In order for this to be possible, such NIR sensors comprise calibration models that must be structured very differently depending on the type and constitution of the flow of substance and the properties to be determined. The quality of these calibration models significantly determines the quality of the analysis of the particular flow of substance. Consequently, there is therefore a need to structure the calibration models so that they may analyze the components of the particular flow of substance with high quality. In this case, the known NIR sensor systems have the particular disadvantage that the calibration models are not flexibly adaptable to changing substance properties and conditions of use.

Thus, in one or some embodiments, various aspects, including a database structure (such as a database structural system that may include one or both of electronic hardware and software) and an agricultural work machine, are disclosed that may create calibration methods that are flexibly adaptable to changing substance properties and conditions of use.

In particular, in one or some embodiments, a database structure (such as a database structure system) for creating calibration models for an NIR sensor system is disclosed. The database structure (such as a database structure system) comprises raw data of the NIR spectra of plant material and/or flows of material, with the raw data being generated by one or more NIR sensor systems assigned to an agricultural work machine (e.g., at least one memory for storing one or both of the raw data or the one or more calibration models). The one or more NIR sensor systems are configured to transmit the raw data via an interface for the data traffic with at least one data processing unit outside of or external to the agricultural machine. The database structure comprises at least one or more calibration models in addition to the raw data and is configured to: receive the raw data for storage in the at least one memory; generate user-specific calibration models by using the saved raw data and/or the calibration models and to provide them to a user; and transmit the one or more user-specific calibration models to a user (various different users are contemplated, as discussed further below). In this way, a calibration method may be used that is flexibly adaptable to changing substance properties and conditions of use, and that may more precisely measure substance properties using NIR sensors.

In one or some embodiments, the user provides a calibration model, and the database structure creates an optimized calibration model considering the saved raw data and/or calibration models. This has the effect that the user may optimize any calibration models that he or she has used via the database structure. In particular, the processor may be configured to: receive a calibration model resident in the agricultural work machine; generate, based on the calibration model received, an optimized calibration model using one or both of the raw data or the calibration models; and transmit the optimized calibration model to the agricultural work machine for use by the agricultural work machine.

Moreover, in one or some embodiments, the database structure may be such that the user defines an application, and the database structure generates a user-specific new calibration model taking into account at least the saved calibration models and raw data. This has the effect that the user may have a suitable calibration model created for any applications without personally having expert knowledge in this field. In this way, the processor may be configured to: receive an indication of an application for the one or more NIR sensor systems; generate, based on the calibration model received, a newly-created calibration model using both of the raw data and the calibration models; and transmit the newly-created calibration model for use in a specific agricultural work machine.

In one or some embodiments, a created calibration model may be efficiently used when the database structure transmits the created calibration model to the particular user, such as to the NIR sensor system assigned to the particular agricultural work machine. In particular, the processor may be configured to: generate the one or more user-specific calibration models by using the raw data generated by an NIR sensor system from a particular agricultural work machine; and transmit the generated one or more user-specific calibration models to the particular agricultural work machine for use by the NIR sensor system resident on the particular agricultural work machine.

In one or some embodiments, the user may retrieve the calibration model created by the database structure and transmit it to the particular NIR sensor system assigned to an agricultural work machine. In particular, this has the effect that the user may exchange calibration models saved in his or her agricultural work machine in a controlled manner. In particular, the processor may be configured to receive a request from the user for the one or more user-specific calibration models. And, responsive to the request, the processor may: generate the one or more user-specific calibration models (or access previously generated user-specific calibration model(s); and transmit the one or more user-specific calibration models to an NIR sensor system assigned to a particular agricultural work machine.

In one or some embodiments, the database structure is configured to modify a calibration model so that an adapted calibration model is derived/created for a special crop type. In this way, the NIR sensor system may be able to detect and analyze any type of crop in a highly flexibly manner. Specifically, the processor may: receive from the user an indication of a special crop type and a calibration model; and generate the one or more user-specific calibration models by modifying the calibration model based on the special crop type so the modified calibration model is derived for the special crop type.

In one or some embodiments, the database structure is configured to create an adapted calibration model taking into account one or more modified environmental conditions and/or one or more changing crop type properties. This may improve the NIR analysis of a detected flow of substance. In particular, the processor may: receive from the user an indication of one or more modified environmental conditions and a calibration model; and generate the one or more user-specific calibration models by modifying the calibration model based on the one or more modified environmental conditions so the modified calibration model accounts for the one or more modified environmental conditions.

In one or some embodiments, the database structure may be such that the raw data from different operating times may be compared with each other so that the same calibration model is taken into account for all operating times. This may allow for a standardized comparison of the data generated by the NIR system at different times. In this context, the operating time may comprise a campaign, and the comparison of the raw data from different operating times within the campaign may be used to correct derived field maps.

In one or some embodiments, the database structure may comprise a so-called “automated process data interpretation” (APDI) module that is configured to recognize or identify incorrect entries that are entered by a user and to correct the incorrect entries taking into account the selected calibration model and the associated raw data. In this context, various types of incorrect entries entered by the user are contemplated. For example, the recognition of misuse may be focused on the entry of the incorrect or wrong crop type since this is a parameter that may be frequently entered incorrectly by the operator in practical use.

In one or some embodiments, the database structure may be such that the user may convert a basic calibration model using the database structure into an expanded calibration model. In turn, the expanded calibration model may then comprise model components that enable the particular NIR sensor system to determine an expanded spectrum of contents. In this way, the user of a calibration model may expand the spectrum of use of his or her NIR sensor system. This is particularly advantageous when the particular NIR sensor system is used in so-called contracting companies that fulfill customer orders and whose customers seek a wide variety of NIR data, such as the composition of a flow of liquid manure, or the composition of a flow of harvested material processed by a forage harvester, or the composition of a flow of harvested material processed by a combine, to cite only a few example applications that may be performed through using a NIR sensor system. Other applications that may analyze different aspects of flows using the NIR sensor system are contemplated.

In one or some embodiments, the analytical quality of the calibration models to be generated with the database structure may be further improved if the database structure is configured to consider stationarily determined sample analysis values in generating the particular calibration model.

In one or some embodiments, the database structure may be configured to create the user-specific calibration models for compensation, wherein the user may pay a one time or user-dependent fee depending on the scope of creating the particular calibration model. In this regard, the processor may determine whether a fee has been paid depending on a scope of creating a particular user-specific calibration model, and responsive to determining that the fee has been paid, generate the particular user-specific calibration model. For the user of the generated calibration models, this may have the advantage that the user only has to pay for creating actually required calibration models.

In one or some embodiments, the database structure may be used inside or along with an agricultural work machine as part of an agricultural work machine system (which may further include the data processing unit along with the database structure system). For example, the agricultural work machine may comprise: an NIR sensor system that is configured to detect NIR spectra of plant material and/or other substances and output them as raw data; an evaluation unit for deriving at least one parameter of the plant material or the other substance in real time from the raw data; and interface communicating with an external at least one data processing unit in order to exchanging data. In one or some embodiments, the data processing unit may comprise a database structure (such as a database structure system) configured to create calibration models for an NIR sensor system, wherein raw data of the NIR spectra of plant material or other substances may be saved in the database structure, wherein the raw data are generated by one or more of the NIR sensors assigned to the agricultural work machines. Moreover, the database structure (such as a database structure system) may comprise one or more calibration models in addition to the raw data and is configured to generate user-specific calibration models by using the saved raw data and/or calibration models and make them available to a user.

In one or some embodiments, the NIR sensor system generates the raw data and transmits them to the database structure. Further, the NIR sensor system may comprise one or more sensor heads and a common evaluation unit that is assigned to each sensor head separately, or that is assigned to all sensor heads. Further, the evaluation unit may comprise sensor software. The spectral data generated by the sensor head may be further processed using the sensor software and the calibration model(s) assigned to this sensor software into sensor data for internal use in the agricultural work machine and into the raw data. In this way, intensive interactive communication between an NIR sensor system and the database structure is possible, which may ensure that the NIR sensor system creates a high-quality NIR analysis of a flow of material.

Moreover, highly flexible communication between the agricultural work machine and the database structure is possible when the raw data generated in the particular evaluation unit is transmitted via an interface (resident on the agricultural work machine) to an external electronic device (e.g., outside of the agricultural work machine). The data transmission paths between the agricultural work machine and database structure may comprise at least one satellite and/or one radio system, and the database structure may be saved in a data processing apparatus, such as in a data cloud or stationary server.

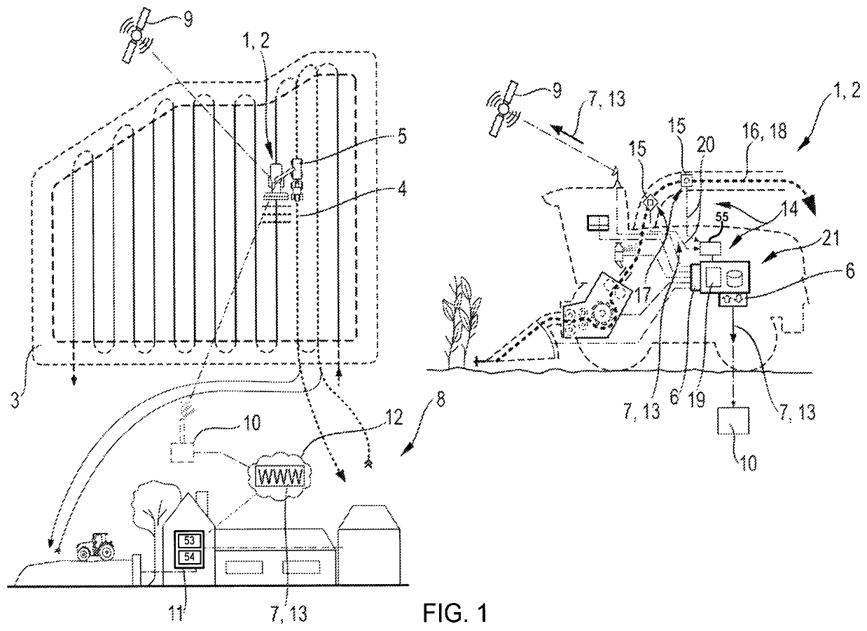

Referring to the figures, FIG. 1 shows an agricultural work machine 1 designed as a forage harvester 2 that harvests a plant crop 4 grown on a field 3, such as corn, and transfers it to a transport vehicle 5. An example forage harvester is disclosed in U.S. Pat. No. 11,109,537, incorporated by reference herein in its entirety. The agricultural work machine 1 may be assigned an interface 6, described in greater detail below, through which its data 7 may be transmitted from the agricultural work machine 1 to the outside 8. The data may be transmitted to the outside 8 for example by satellite system 9 or stationary radio system 10, wherein the data 7 are either transmitted to stationary servers 11 or to a so-called cloud 12. The transmitted data 7 may comprise at least the raw data 13, described in detail below, generated by at least one NIR sensor system 14 assigned to the agricultural work machine 1.

As shown in FIG. 1, the NIR sensor system 14 assigned to the agricultural work machine 1 designed as a forage harvester 2 comprises two NIR sensor heads 15 which are known per se and therefore will not described further. It lies within the scope of the invention that the agricultural work machine 1 may be designed as any type of agricultural work machine; harvesters such as combines and special crop harvesting machines or liquid manure tankers are mentioned here merely as examples. Other applications are contemplated. Moreover, it lies within the scope of the invention that the agricultural work machine 1 may be assigned only one NIR sensor head 15 or a plurality of NIR sensor heads 15 (e.g., at least 2 NIR sensor heads 15; at least 3 NIR sensor heads 15; etc.). The harvested plant crop 4 travels through the forage harvester 2 as a flow of material comprising (or consisting of) plant material 16. The plant material 16 passes the particular sensor region 17 of the NIR sensor head(s) 15 on its way through the forage harvester 2. Via spectral analysis, spectral data 20 are generated by the NIR sensor system 14 in a manner known per se of the contents 18 to be identified. In addition to the directly detectable contents such as protein, fat and sugar, any contents 18 may be determined by using suitable calibration models 19.

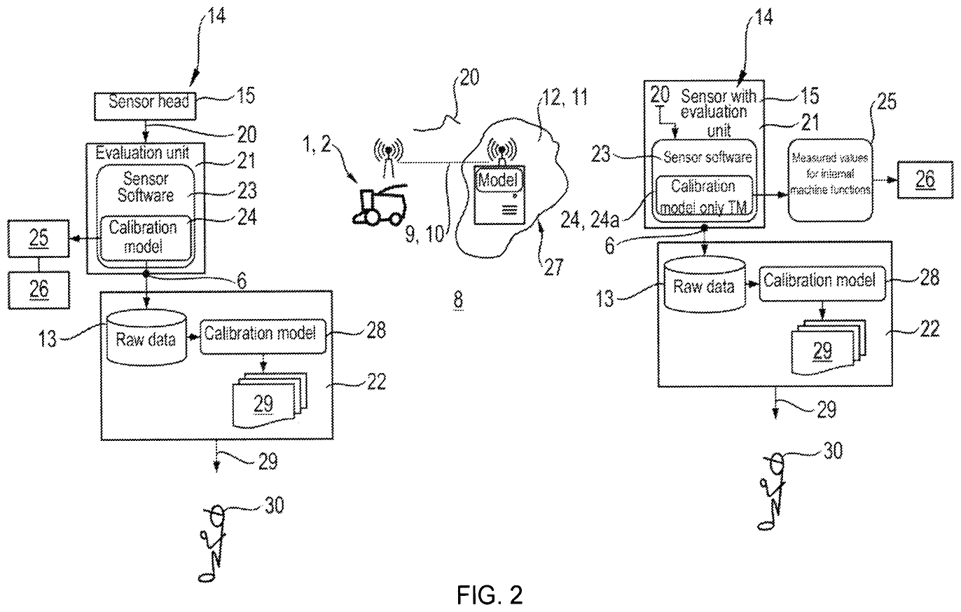

The spectral data 20 generated by the NIR sensor heads 15 are transmitted to an evaluation unit 21, wherein the evaluation unit 21 is either arranged outside of the particular sensor head 15 as depicted in FIG. 1 in the agricultural work machine 1, or is integrated directly in the particular sensor head 15 as depicted in FIG. 2. In a manner to be described further, in one or some embodiments, the raw data 13 are generated in the particular evaluation unit 21 and are transmitted by the interface 6 to the outside 8, a satellite 9 and/or radio system 10, and from there to a data cloud 12 and/or to a server 11.

Evaluation unit 21 may include computing functionality, such as at least one processor and at least one memory (not shown), which may be the same or similar to processor 53 and memory 54 discussed below. The computing functionality may be manifested in one of several ways, such as illustrated in the figures, such as within the evaluation unit 21, including sensor software 23.

In one or some embodiments, external data processing unit (discussed below), such as server 11 and/or data cloud 12, may include computing functionality. As depicted in FIG. 1, server 11 may include may comprise any type of computing functionality, such as at least one processor 53 (which may comprise a microprocessor, controller, PLA, or the like) and at least one memory 54 in order to perform the disclosed analysis and/or any other processing disclosed herein. The memory 54 may comprise any type of storage device (e.g., any type of memory). Though the processor 53 and memory 54 are depicted as separate elements, they may be part of a single machine, which includes a microprocessor (or other type of controller) and a memory. Examples of computer-readable media include computer-readable non-transitory storage media, such as a random-access memory (RAM), which may be SRAM, DRAM, SDRAM, or the like, read-only memory (ROM) 708, which may be PROM, EPROM, EEPROM, or the like. RAM and ROM hold user and system data and programs, as is known in the art. Thus, the processor 53 and/or the memory 54 may include a computer-readable medium for determining a portion of one or both of broken grain or non-grain components in a stream of harvested material, comprising instructions stored thereon, that when executed on a processor 53, performs any one, any combination, or all of the steps described herein.

The processor 53 and memory 54 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. Alternatively, or in addition, data cloud 12 may include the same or similar computing functionality, such as including both processor 53 and memory 54.

FIG. 2 schematically shows the generation of the raw data 13 by the NIR sensor system 14 and its transmission to the database structure 22 via sensor interface (illustrated in FIG. 1) according to one or some embodiments. Depending on the embodiment, the particular sensor head 15 may comprise an evaluation unit 21 arranged in the sensor head 15 or externally. The particular evaluation unit 21 comprises so-called sensor software 23. The spectral data 20 generated by the sensor head 15 may be processed further by the sensor software 23 and the calibration model(s) 24 assigned to this sensor software 23 (e.g., a calibration model of dry material 24a is illustrated in FIG. 2 merely for exemplary purposes) into sensor data 25 for internal use in the agricultural work machine 1 and into the raw data 13 according to one aspect of the invention. In a manner known per se, the sensor data 25 generated for internal use may be used to optimize certain operating parameters 26 of the agricultural work machine 1. For example, reference is made here to the known determination of the percentage of dry matter that is ultimately considered in the forage harvester 2 in the creation of the so-called chaff length, wherein the chaff length may be adjusted responsive to a determination of the percentage of dry matter (e.g., the chaff length is adjusted to be increasingly shorter the greater the percentage of dry matter in the plant material 16).

The raw data 13 generated in the particular evaluation unit 21 may be transmitted by the interface 6 to the outside 8. As described previously, these raw data 13, in the simplest case the unprocessed spectral data 20, may be transmitted by suitable data transmission paths such as by satellite 9 or radio systems 10 to the database structure 22. Thereafter, the database structure 22 may for example be saved in a data cloud 12 or a stationary server 11, with the server 11 and/or the data cloud 12 forming the external data processing unit 27 in one aspect of the invention. At least one or more calibration models 28 may be retrievably saved in addition to the raw data 13 in the database structure 22 according to one aspect of the invention (e.g., the one or more calibration models 28 may be correlated with the saved raw data). The database structure 22 may be configured in a manner to be described in greater detail to generate user-specific calibration models 29 by using the saved raw data 13 and/or calibration models 28 and to provide these to a user 30. Users 30 may be understood broadly to include any one, any combination, or all of: the immediate operator of the agricultural work machine 1; an operator managing a machine fleet; or the particular control and regulation device of an agricultural work machine 1 itself.

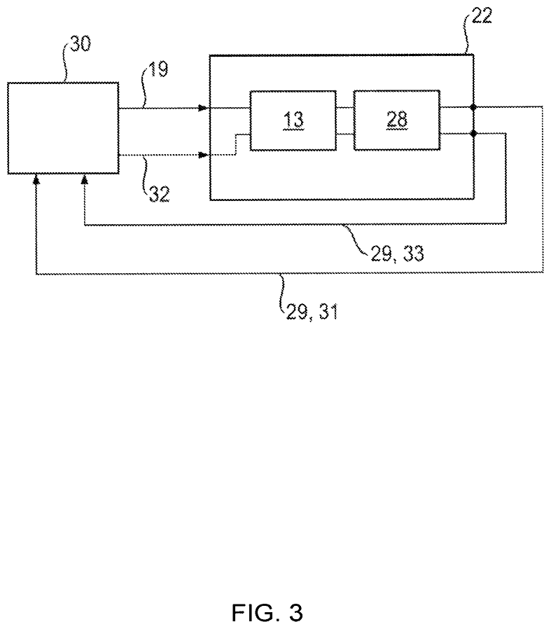

In one or some embodiments depicted according to FIG. 3, the database structure 22 may be such that a user 30 provides a calibration model 19, and the database structure 22 creates a user-specific calibration model 29 in the form of an optimized calibration model 31 and transfers it to the user 30 taking into account the saved raw data 13 and/or calibration models 28. The database structure 22 may however also be such that the user 30 defines an application 32 (e.g., a use of the NIR sensor system, such as for analysis of the composition of a flow of liquid manure, the composition of a flow of harvested material processed by a forage harvester, or the composition of a flow of harvested material processed by a combine), and the database structure 22, using an indication of the application 32, generates a user-specific calibration model 29 in the form of a newly created calibration model 33 and transfers it to the user 30 taking into account at least the saved calibration models 28 and/or raw data 13. In this regard, the user may provide one or both of the calibration model 19 or the application 32 to the database structure 22 in order to create the user-specific calibration model 29. The database structure 22 may be such that it transfers the generated user-specific calibration models 29 either directly to the particular NIR sensor system 14, or to another user 30, such as the operator of the agricultural work machine 1 or an operator managing a machine fleet. In one embodiment, the database structure 22 may also be such that the user 30 retrieves the user-specific calibration model 29 created by the database structure 22 and transfers it to the particular NIR sensor system 14 assigned to an agricultural work machine 1. After transferring the generated user-specific calibration model 29 to the particular NIR sensor system 14, the calibration model 19 previously saved therein is replaced by this newly created or modified user-specific calibration model 29 (e.g., a version of the calibration model 19 previously saved in the particular NIR sensor system is at least partly modified to generate the modified user-specific calibration model 29) so that the NIR sensor system 14 then operates with this newly created or modified user-specific calibration model 29.

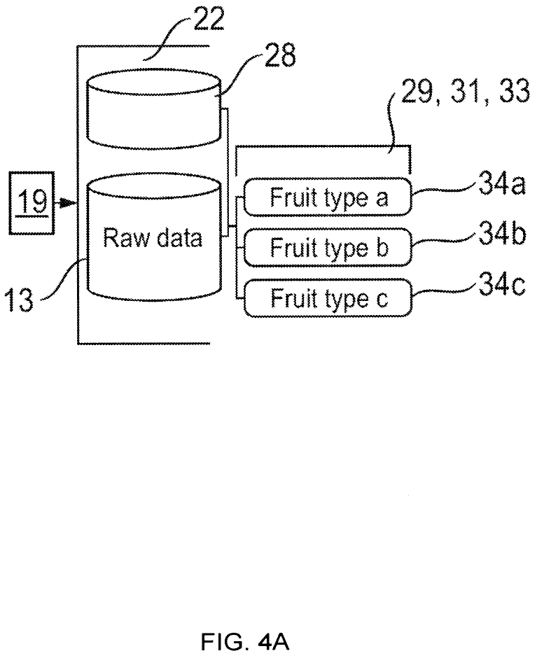

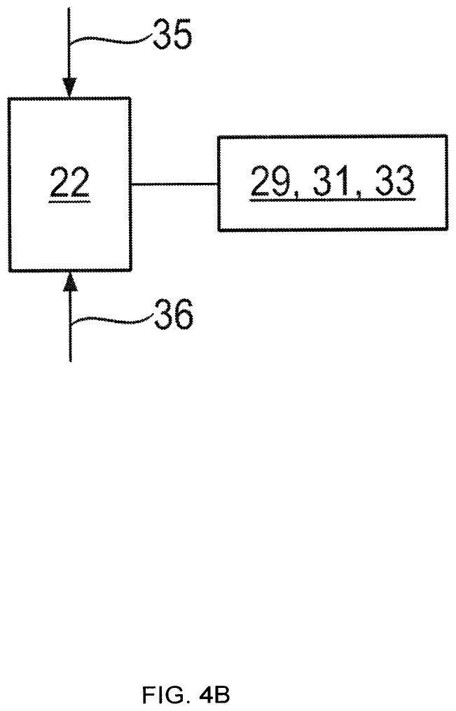

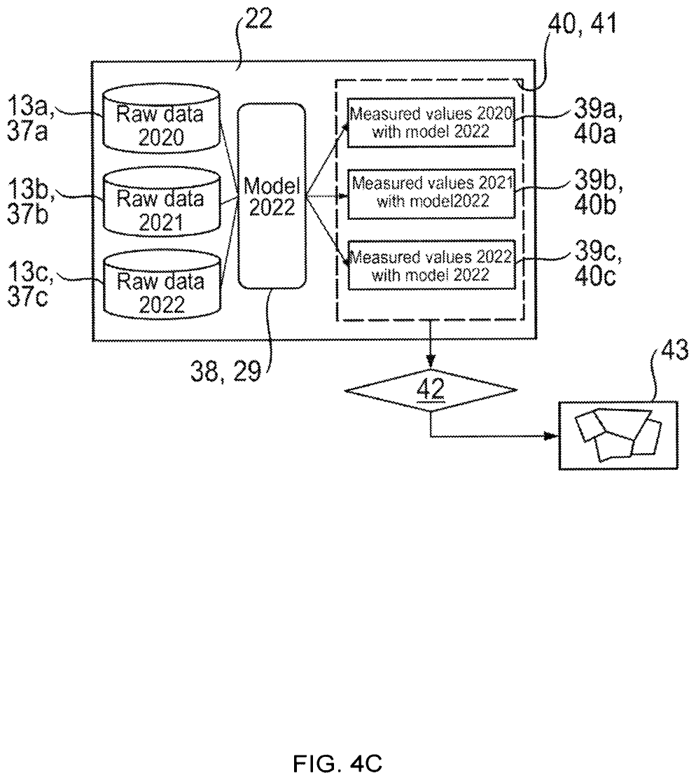

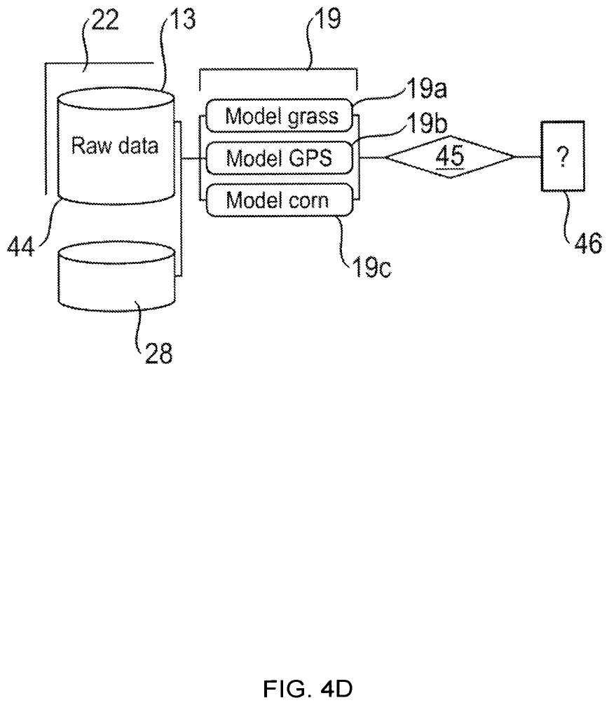

According to one or some embodiments as depicted in FIG. 4a, a calibration model 19 may be modified using the database structure 22 into a user-specific calibration model 29 by using the saved raw data 13 and/or the saved calibration model 28 so that an adapted calibration model 29, 31, 33 for a special crop type 34a, 34b, 34c, . . . 34i (though only 34a, 34b, 34c are depicted in FIG. 4A) is derived.

Bearing in mind that the further or new development of crop types 35 and changing environmental conditions 36 may influence the sensing precision of the NIR sensor systems 14, the database structure 22 according to one or some embodiments depicted in FIG. 4b may be configured to create an adapted user-specific calibration model 29, 31, 33 taking into account the modified environmental conditions 36 and/or the newly developed crop types 35.

Moreover, the database structure 22 according to one or some embodiments depicted in FIG. 4c may also be such that raw data 13a, 13b, 13c from different operating times 37 are compared with each other in that the same calibration model 38 is considered for all operating times 37a, 37b, 37c (e.g., three different operating times as depicted by each of 37a, 37b, 37c), wherein the same calibration model 38 may be one of the above-described user-specific calibration models 29. In this manner, the database structure 22 generates measured values 39a, 39b, 39c that standardize the contents 18 of the particular plant material 16 of a certain time period 40a, 40b, 40c (with measured value 39a for time period 40a, measured value 39b for time period 40b, and measured value 39c for time period 40c) to the underlying common calibration model 38. In one user-relevant embodiment, the time period 40 comprises a campaign 41, wherein in one or some embodiments, a campaign may comprise a harvesting campaign, a fertilization campaign, etc. The comparison 42 of the raw data 13a, 13b, 13c standardized in the described manner may ultimately be used to correct so-called field maps 43 that are known per se. In one or some embodiments, the field maps 43 are yield maps or fertilization maps.

In one or some embodiments as depicted in FIG. 4d, the database structure 22 may comprise a so-called APDI module 44 in addition to the raw data 13 and the saved calibration models 28, wherein APDI stands for “automated process data interpretation” and technically means that the determined raw data 13 are checked for plausibility 45. In a user-relevant embodiment, the APDI module 44 may be used to check whether the user 30, such as the operator (e.g., the driver of the agricultural work machine 1) has made incorrect entries 46 taking into account the calibration model 19 selected in the particular harvester 1, such as, for example, the calibration model “grass” 19a, or “whole plant silage” 19b, or “corn” 19c, and the associated raw data 13. In the simplest case, the incorrect entry 46 may relate to the entry of the wrong type of material in the selected calibration model 19a, 19b, 19c.

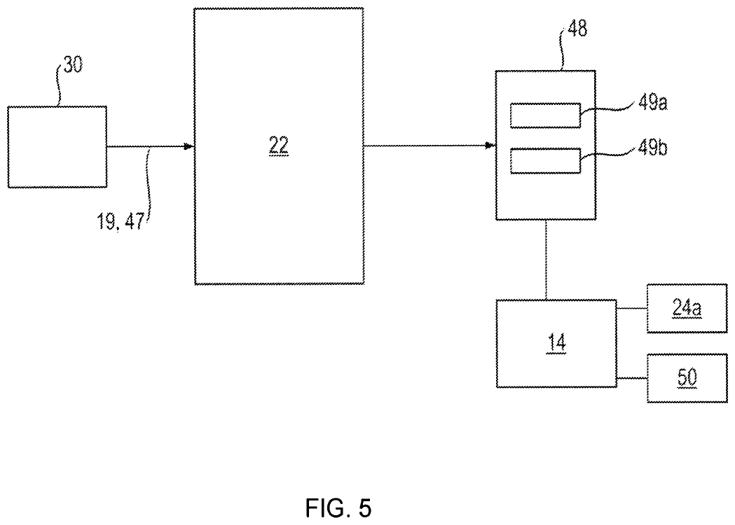

Moreover, in one or some embodiments as depicted in FIG. 5, the database structure 22 may be such that the user 30 transmits a basic calibration model 47, that in the simplest case is the calibration model 19 used in the agricultural works machine 1, to the database structure 22. Using the database structure 22 and/or the transferred calibration model 19, the basic calibration model 47 may be converted or modified into an expanded calibration model 48, wherein the expanded calibration model 48 then comprises model components 49a, 49b that enable the particular NIR sensor system 14 to determine an expanded or extended spectrum of properties of the flow of substance. For example, the agricultural work machine 1 may be equipped with an NIR sensor system 14 that only comprises the model detection of dry material 24a (see FIG. 2). Then, the user 30 may integrate another function, for example the determination of additional contents 50, into this calibration model 19 in the described manner via the database structure 22.

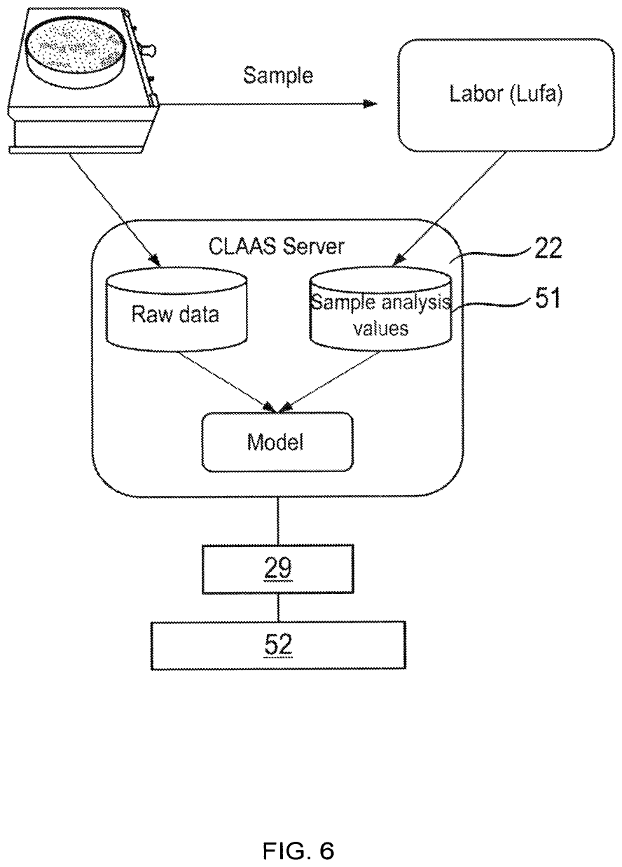

To further increase the quality of the user-specific calibration models 29 to be generated by the database structure 22, the database structure 22 may moreover be configured to consider the stationarily determined sample analysis values 51 according to FIG. 6 when generating the particular user-specific calibration model 29. Moreover, the database structure 22 may be configured such that the user-specific calibration models 29 are created for compensation, wherein the user 30 pays a one time or user-dependent fee 52 depending on the scope of creating the particular calibration model 29.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### REFERENCE NUMBER LIST

1 Agricultural work machine
2 Forage harvester
3 Field
4 Plant crop
5 Transport vehicle
6 Interface
7 Data
8 External
9 Satellite
10 Stationary radio system
11 Server
12 Cloud
13 Raw data
14 NIR sensor system
15 NIR sensor head
16 Plant material
17 Sensing range
18 Contents
19 Calibration model
20 Spectral data
21 Evaluation unit
22 Database structure
23 Sensor software
24 Calibration model
25 Sensor data
26 Operating parameters
27 Data processing unit
28 Calibration model
29 User-specific calibration model
30 User
31 Optimized calibration model
32 Application
33 Newly created calibration model
34 Crop type
35 Newly developed crop type
36 Changed environmental conditions
37 Operating time
38 Calibration model
39 Measured value
40 Time period
41 Campaign
42 Comparison
43 Field map
44 APDI module
45 Checking plausibility
46 Checking incorrect entry
47 Basic calibration model
48 Expanded calibration model
49 Model components
50 Additional contents
51 Sample analysis value
52 Payment
53 Processor
54 Memory
55 Sensor interface

1. A database structure system configured to create one or more calibration models for a near-infrared (NIR) sensor system, the database structure system comprising:
at least one memory configured to store:
raw data of NIR spectra of one or both of plant material or flow of material, the raw data being generated by one or more NIR sensor systems assigned to an agricultural work machine; and
one or more calibration models;
at least one processor in communication with the memory, the at least one processor configured to:
receive the raw data for storage in the at least one memory;
generate one or more user-specific calibration models by using one or both the raw data or the one or more calibration models; and
transmit the one or more user-specific calibration models to a user.

2. The database structure system of claim 1, wherein the processor is configured to receive a calibration model resident in the agricultural work machine;
wherein the processor is configured to generate, based on the calibration model received, an optimized calibration model using one or both of the raw data or the calibration models; and
wherein the processor is configured to transmit the optimized calibration model to the agricultural work machine for use by the agricultural work machine.

3. The database structure system of claim 1, wherein the processor is configured to receive an indication of an application for the one or more NIR sensor systems;
wherein the processor is configured to generate, based on the calibration model received, a newly-created calibration model using both of the raw data and the calibration models; and
wherein the processor is configured to transmit the newly-created calibration model for use in a specific agricultural work machine.

4. The database structure system of claim 1, wherein the processor is configured to generate the one or more user-specific calibration models by using the raw data generated by an NIR sensor system from a particular agricultural work machine; and
wherein the processor is configured to transmit the generated one or more user-specific calibration models to the particular agricultural work machine for use by the NIR sensor system resident on the particular agricultural work machine.

5. The database structure system of claim 1, wherein the processor is configured to receive a request from the user for the one or more user-specific calibration models; and
responsive to the request, the processor is configured to:
generate the one or more user-specific calibration models; and
transmit the one or more user-specific calibration models to an NIR sensor system assigned to a particular agricultural work machine.

6. The database structure system of claim 1, wherein the processor is further configured to receive from the user an indication of a special crop type and a calibration model; and
wherein the processor is configured to generate the one or more user-specific calibration models by modifying the calibration model based on the special crop type so the modified calibration model is derived for the special crop type.

7. The database structure system of claim 1, wherein the processor is further configured to receive from the user an indication of one or more modified environmental conditions and a calibration model; and
wherein the processor is configured to generate the one or more user-specific calibration models by modifying the calibration model based on the one or more modified environmental conditions so the modified calibration model accounts for the one or more modified environmental conditions.

8. The database structure system of claim 1, wherein the processor is further configured to receive from the user an indication of one or more changing crop type properties and a calibration model; and
wherein the processor is configured to generate the one or more user-specific calibration models by modifying the calibration model based on the one or more changing crop type properties so the modified calibration model accounts for the one or more changing crop type properties.

9. The database structure system of claim 1, wherein the processor is configured to compare the raw data from different operating times with each other so that a same calibration model is considered for each of the different operating times.

10. The database structure system of claim 9, wherein the different operating times comprises a campaign; and
wherein the processor is configured to use the comparison of the raw data from different operating times to correct derived field maps.

11. The database structure system of claim 1, further comprising an automated process data interpretation (APDI) module configured to, based on a selected calibration model and associated raw data, recognize and correct one or more incorrect entries by a user.

12. The database structure of claim 11, wherein at least one incorrect entry comprises wrong crop type.

13. The database structure system of claim 1, wherein the processor is configured to convert a basic calibration model into an expanded calibration model; and
wherein the expanded calibration model comprises one or more model components configured to enable a particular NIR sensor system to determine an extended spectrum of contents.

14. The database structure system of claim 1, wherein the processor, in generating the one or more user-specific calibration models, is configured to consider stationarily determined sample analysis values.

15. The database structure system of claim 1, wherein the processor is further configured to determine whether a fee has been paid depending on a scope of creating a particular user-specific calibration model; and
responsive to determining that the fee has been paid, generate the particular user-specific calibration model.

16. An agricultural work machine system comprising:
an agricultural work machine comprising:
a near-infrared (NIR) sensor system configured to detect NIR spectra of one or both of plant material or other substances and to output them as raw data;
an evaluation unit configured to derive at least one parameter of the one or both of the plant material or the other substances in real time from the raw data;
an interface for communicating with at least one data processing unit external to the agricultural work machine;
the data processing unit comprising:
a database structure system configured to create one or more calibration models for the NIR sensor system resident on the agricultural work machine;
wherein the database structure system comprises:
at least one memory configured to store:
the raw data of the NIR spectra of the one or both of the plant material or the other substances, the raw data being generated by the NIR sensor system assigned to the agricultural work machine; and
one or more calibration models;
at least one processor in communication with the memory, the at least one processor configured to:
receive the raw data for storage in the at least one memory;
generate one or more user-specific calibration models by using one or both the raw data or the one or more calibration models; and
transmit the one or more user-specific calibration models to a user.

17. The agricultural work machine system of claim 16, wherein the NIR sensor system is configured to generate the raw data;
wherein the interface is configured to transmit the raw data it to the database structure system;
wherein the NIR sensor system comprises one or more sensor heads;
wherein a common evaluation unit is assigned to each sensor of the one or more sensor heads separately or to all of the one or more sensor heads;
wherein the common evaluation unit comprises sensor software; and
wherein the sensor software and one or more calibration models assigned to the sensor software are configured to process the NIR spectra generated by the one or more sensor heads for use internally in the agricultural work machine or for generating the raw data.

18. The agricultural work machine of claim 17, wherein the interface is configured to transmit the raw data generated by the evaluation unit;
wherein one or more data transmission paths between the agricultural work machine and the database structure system comprise one or both of satellite system or a radio system; and
wherein the database structure system comprises a data cloud.

19. The agricultural work machine of claim 17, wherein the interface is configured to transmit the raw data generated by the evaluation unit;
wherein one or more data transmission paths between the agricultural work machine and the database structure system comprise one or both of satellite system or a radio system; and
wherein the database structure system comprises a stationary server.
